(19) United States
(12) Patent Application Publication
(10) Pub. No.: US 2002/0169627 A1
(43) Pub. Date: Nov. 14, 2002

(54) Novel ASP approach with commoditized service function

(75) Inventors: Alex J. Kolt, San Ramon, CA (US); Greg Shenkman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Exigen Properties, Inc., San Francisco, CA

(21) Appl. No.: 10/101,815

(22) Filed: Mar. 19, 2002

Related U.S. Application Data
(60) Provisional application No. 60/277,353, filed on Mar. 19, 2001.

(51) Int. Cl. G06F 17/60

(52) U.S. Cl. 705/1

(57) ABSTRACT

The present invention provides a method of centrally providing common industry applications to organizations within a common industry that includes identifying functions for various applications within the common industry and determining which functions may be centrally performed regardless of the application that requires a function. The method further includes providing a system that centrally performs the functions applying the system to the various applications.

### CROSS-REFERENCES TO RELATED APPLICATIONS

This application claims priority to U.S. Provisional Application Ser. No. 60/277,353 (Attorney Docket No. 021074-000100US) filed Mar. 19, 2001 which is herein incorporated by reference for all purposes.

### BACKGROUND OF THE INVENTION

It is commonly observed by those skilled in business financial management and enterprise information technology (IT) that currently many large corporations deal with challenges on a per-case basis. The corporations tend to stumble from one IT project to another, as each problem arises.

Typically, management tries to solve problems as they appear in their business by using some IT projects to package business processes. Very often they either acquire some piece of ready-made software that only addresses a narrow aspect of their business and often requires massive support and implementation, or, often even worse, in some cases they try to make a home-grown solution, as a patch, for such problems.

Failure rates among these projects are generally very high, and even if a project is finished, there is no guarantee of a clear return on time, effort, and money expended. Although a project may close successfully, meaning that its software is working, the cost of preparation, including all the investments charged to the project for development of the business case, selection of software, purchase or design, and implementation may by far exceed the value added to the business as a result of implementation of the solution. In such cases, very often the argument is made that it's not a question of how much it costs to solve the problem, but how much it costs to not solve the problem, in the form of lost customers.

What is clearly needed is a novel, improved approach, one that takes the guesswork out of IT projects and greatly improves manageability by providing utility-like, ready-packaged projects or applications for whole market segments. Such solutions would cover a vast majority of the actual business operations required for a market segment's operations. Providing those solutions at a very low, manageable cost, preferably in a pay-as-you-go model, results in tangible returns almost immediately, because the initial investment in project phases such as selection, implementation, and other steps is minimal.

An approach that has been widely implemented in the manufacturing sector (EMS). However, the industrial sector has a history of working with utilities (e.g., power, steam, telephone, communications, etc.), whereas the service sector, until now, has prided itself in being noncommoditized and thus not suitable for such a “utility” model.

### SUMMARY OF THE INVENTION

The present invention provides a method of centrally providing common industry applications to organizations within a common industry that includes identifying functions for various applications within the common industry and determining which functions may be centrally performed regardless of the application that requires a function. The method further includes providing a system that centrally performs the functions applying the system to the various applications.

In accordance with one aspect of the present invention, the system is a stand-alone package.

In accordance with another aspect of the present invention, the system is an application service provider.

In accordance with yet another aspect of the present invention, the application service provider is in-house.

Thus, with respect to a company's current activities, the present invention provides a model that allows each industry sector participant to derive maximum available scale economies, while simultaneously freeing themselves for all practical purposes from capacity constraints. By aggregating the largest possible volume of transactions into a uniform process executed by a single service-providing entity, the model spreads the fixed costs of that process across the largest available base, thus leading to the lowest possible unit cost. Because the capacity of the central utility is significantly greater than that required or utilized by any single participant, the utility may also have enough flexibility to accommodate fairly wide variations in volume for any given company, thus allowing companies to shrink or expand their “virtual capacity” as required.

The present invention thus offers service industries dramatic economic benefits in three areas: current activities, new initiatives and ancillary or “halo” effects.

Other features and advantages of the present invention will be understood upon reading and understanding the detailed description of the preferred exemplary embodiments, found herein below in conjunction with reference to the drawings in which like numerals represent like elements.

### BRIEF DESCRIPTION OF THE DRAWINGS

FIG. 1 graphically illustrates a typical prior art patchwork of application solutions;

FIG. 2 graphically illustrates a model in accordance with the present invention;

FIG. 3a is a value equation;

FIG. 3b graphically illustrates steps typically implemented in an IT project;

FIG. 4 further illustrates the model in accordance with the present invention; and

FIG. 5 illustrates a simplified overview of the architecture of the system in accordance with the present invention.

### DESCRIPTION OF SPECIFIC EXEMPLARY EMBODIMENTS

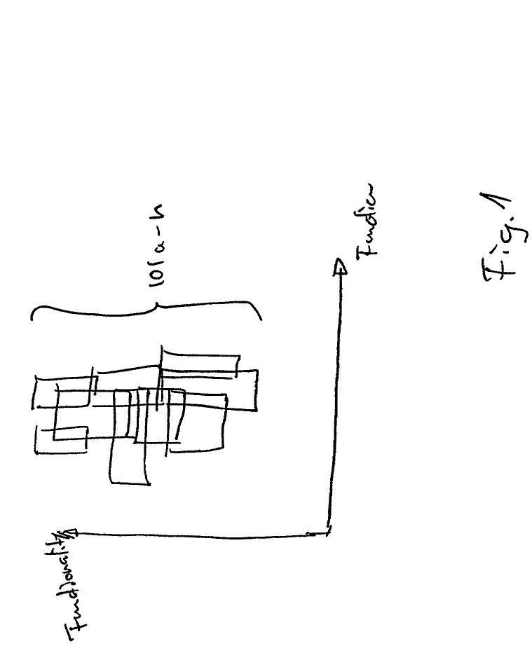

FIG. 1 illustrates a typical patchwork of application solutions commonly used today in enterprises. An example of such an enterprise is in the financial area, such as banks, insurance companies, telecom companies, and other companies with large areas devoted to financial services. In this diagram, on the horizontal axis is the function, such as invoicing, billing, tracking, management of resources, etc. On the vertical axis, for example, is functionality, which means how deep into that segment the actual application works. The present invention is not limited to enterprises of the financial industry, but may be widely applicable to any industry that relies heavily on IT to solve some or all of its problems. Such industries may include but are not limited to telecomm, transport, airlines, government, (all levels), and other, similar enterprises.

Typically, a historically grown patchwork of applications for various industries has some overlap, so some functions exist in more than one application, and are not used in one package but are in another. Moreover, such a conglomeration of applications tends to be “glued” together somehow with, for example, scripts written in-house and other kinds of software and paper procedures. All these software packages are represented together in FIG. 1 as elements 101 a through n.

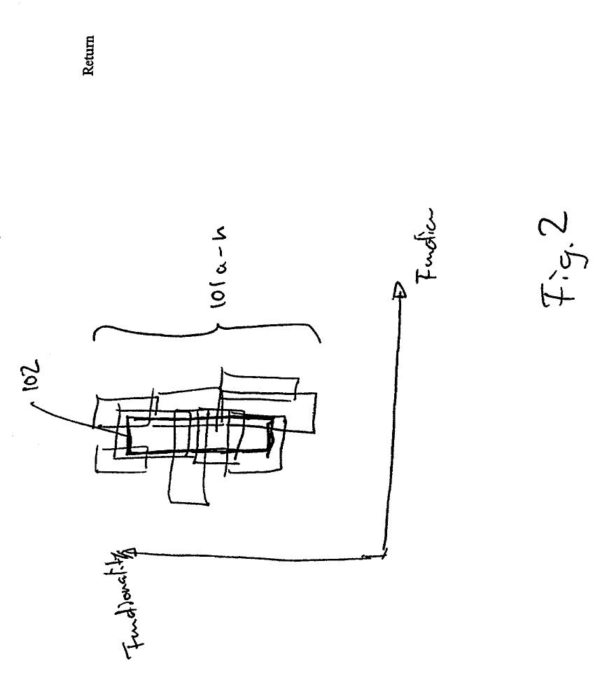

FIG. 2 graphically illustrates a model in accordance with the present invention. The actual operation of such a typical enterprise may require functions represented as those falling within a rectangle 102 in FIG. 2. These required functions 102 may typically comprise less than, for example, 7 percent of the total functions of all the software pieces represented in FIG. 2, considering functions that overlap and functions that are outside the scope of the operation entity (such as bank, insurance company, telecom company, etc.) and therefore are not needed, but cover more than 80 percent of the requirements for such a business.

If these functions 102 were to be offered or, for example, 90 percent of functions 102 were to be offered as a standard, ready-made application for a particular industry, it would definitely be more cost-efficient for enterprises within that particular industry to obtain a package comprising functions 102. Such industry enterprises could buy the package or, more preferably, obtain it on a pay-as-you-go basis, both in-house and in an application service provider (ASP) model. Such a model would always allow the enterprise to obtain package updates, thus keeping abreast with the latest industry trends, without having to invest any money in yet another IT project. In some cases, however, enterprises may prefer to have full control of the software and just buy a shrink-wrapped product, which essentially provides the same services as the ASP model, but with in-house control of the software.

In yet other cases, for various reasons, an enterprise may decide to implement a mix of ASP and in-house operations.

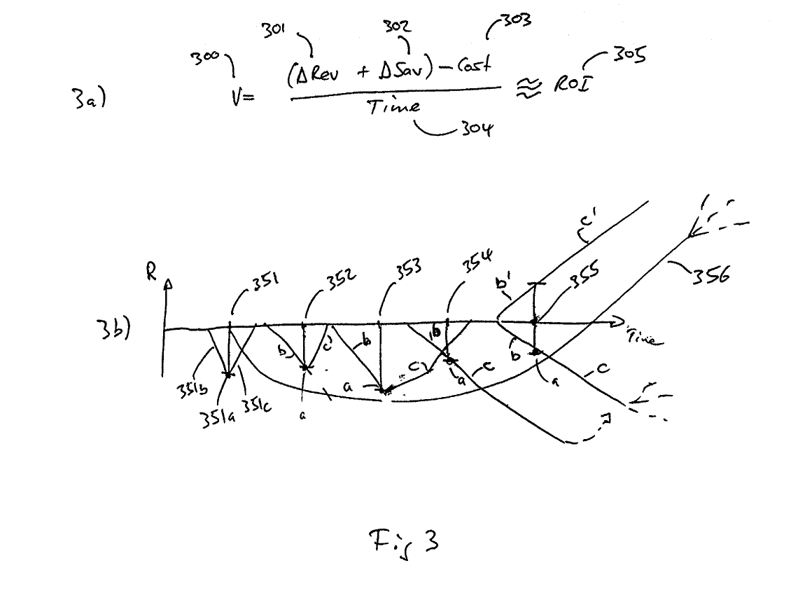

FIG. 3 illustrates effort versus return on a typical IT project. FIG. 3a is a value equation, where the value 300 equals the sum of the increased revenue 301 and the increased savings 302, less the cost of the project 303, divided over time 304, yielding return 305.

FIG. 3b illustrates the steps typically implemented in an IT project in current practice:

A first step 351 typically represents a business case developed for a new function. An expense line goes down to point 351a, typically ramping down along line 351b, and then up along line 351c once the preparing the business case is completed.

Similarly, at the next step 352, again an expense is tracked to and from point 352a for a selection process to evaluate different packages available.

At step 353, a buy decision is made at point 353a and the product is acquired. Again, incurred expenses are depicted along lines 353b and 353c.

At point 354 implementation is begun, and again expenses occur along line 354b. Typically, point 354 expenses continue for quite a while into the operation process, because large software packages, for example, those provided by business software publishers, such as SAP, are cumbersome and complex to implement.

Finally, at point 355, in many cases months or even years into the process, operation may begin, at which point an operation cost is incurred along lines 355b and 355c. Also at this point, however, a return is finally generated along lines 355b′ and 355c ′.

Curve 356 represents the return. It may be clearly seen that as a result of integration of all these elements 351 through 355 over a very long period, typically around 18 months or longer, this curve 356 remains in negative territory on the return, represented by the axis R, and only 2, 3 or 4 years out does curve 356 start to move into positive territory. The timing and extent of curve 356 depends, of course, on factors such as the actual costs of implementation and operation, as indicated by dotted lines at the end of lines 354c and 355c, versus the planned numbers.

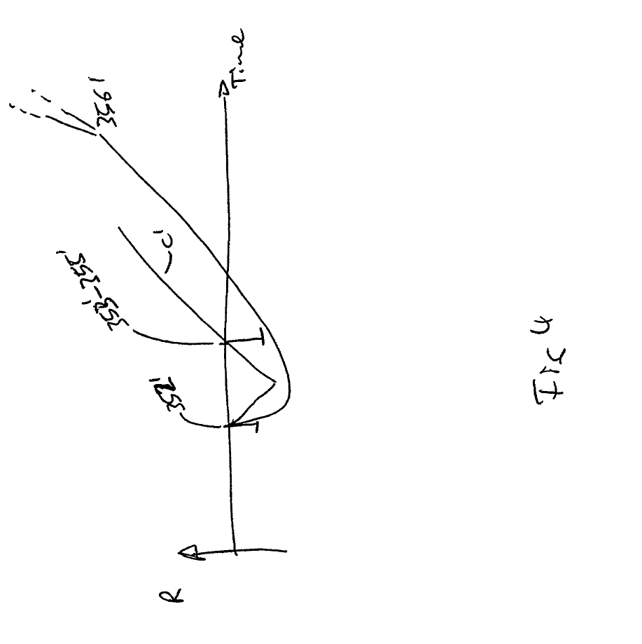

FIG. 4 further illustrates the model in accordance with the present invention. According to the steps illustrated in FIG. 4, the entire process illustrated in FIG. 3 may be greatly reduced. For example, the business case preparation 351 and selection process 352 may be combined into step 352′. Likewise, the buy, implement and operate steps 353, 354, and 355 are all melded together into one step 353′-355′. Factors contributing to the combination of steps 353, 354, and 355 include the following:

Because this novel model comprises ready-made software, it comes ‘out of the box’ already implemented (when using an ASP model—minor adaptations for data access may still be required)

Because when, in the case where the model is ASP-based, there are no implementation costs

Because the model is immediately ready to operate, it may immediately contribute to revenue, which is illustrated in FIG. 4 as c′.

In the ASP model, payment is preferably a percentage of revenue generated by the software. Therefore, the enterprise incurs no expenses for operation unless it realizes corresponding real revenue from the same operation. Thus, return curve 356′ moves much sooner into positive territory, typically within only a few weeks following the beginning of preparation of the business case.

Similar formulas may be applied for the in-house operations mode and may result in higher or lower percentages, depending on such factors as actual cost of operation versus support costs, etc.

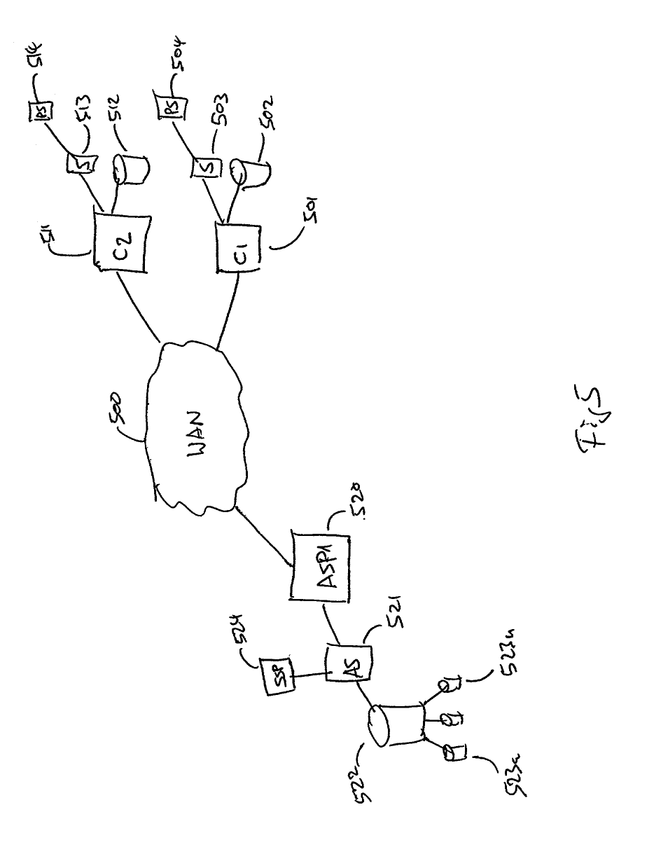

FIG. 5 illustrates a simplified overview of the architecture of the system in accordance with the present invention, with, for example, two typical customers. Customer C1 has site 501 containing a server 503, a database 502, and its current proprietary software 504 running on server 503. Customer C2 likewise has its site 511, containing its server 513, its database 512, and its current proprietary software 514, which may or may not be the same as the software 504 of customer C1.

In this example, the two customers are linked to the ASP provider ASP1 whose site is 520, through a WAN 500, which could be the Internet, a private network, or a virtual private network running on the Internet, depending on the environment, security, and other conditions and requirements of the customers.

ASP1 preferably includes an application server 521 used for the implementation and operation of its software. A standard software package 524 is running on ASP1 server 521, and a common database 522, shared by all customers, also resides on server 521. In addition, each customer may have its own specific database, for example, databases 523 a through n; or, in some cases, depending on the customer's requirements, a customer's data base may reside on the customer's local server and be accessed by software package 524 through the WAN connection at the customer's site.

As previously mentioned, the ASP model of FIG. 5 is only one of various implementations of the present invention. It is clear to a person skilled in the art that an in-house operation or a mixed-mode operation would require adaptations of the structure of the system, which are not practical to illustrate here in all possible configurations. It is also clear that there are many and various different structures of system architecture that may apply both to the presented ASP model as well as to the other types or models mentioned.

Thus, with respect to a company's current activities, the present invention provides a utility model that allows each participant to derive maximum available scale economies, while simultaneously freeing themselves for all practical purposes from capacity constraints. By aggregating the largest possible volume of transactions into a uniform process executed by a single service-providing entity, the model spreads the fixed costs of that process across the largest available base, thus leading to the lowest possible unit cost. Because the capacity of the central utility is significantly greater than that required or utilized by any single participant, the utility may also have enough flexibility to accommodate fairly wide variations in volume for any given company, thus allowing companies to shrink or expand their “virtual capacity” as required.

For new initiatives, the utility model offers the added benefit of having one's competitors share the cost of developing needed functionality. Rather than each company spending large amounts of money on CRM, web-based self-service, or other needed capability enhancements, the utility model may incur that cost once, and then amortize the expense over the entire industry (or at least a significant part of it).

The utility model also offers some additional financial benefits, particularly to its initial participants. For a large insurance or financial firm involved in the creation of a utility entity, a significant amount of infrastructure (i.e., buildings, equipment, etc.) may be moved off the company's balance sheet. Similarly, a large reduction in headcount (and associated overhead) may be achieved by moving the appropriate functional organizations into the utility structure.

The utility approach allows large organizations to capitalize on what they're good at, by leveraging it across the industry. It also allows them to compensate for their weaknesses, by tapping into the collective capabilities of the industry.

Finally, moving non-differentiating business processes into the utility structure frees up management bandwidth and scarce resources to focus on the areas that will enable a company to excel in its core business.

Having described specific preferred embodiments of the invention with reference to the accompanying drawings, it is to be understood that the invention is not limited to those precise embodiments and that various changes and modifications may be effected therein by one skilled in the art without departing from the scope or spirit of the invention as defined in the appended claims.

What is claimed is:

1. A method of centrally providing common industry applications to organizations within a common industry, the method comprising:
a. identifying functions for various applications within the common industry;
b. determining which functions may be centrally performed regardless of the application that requires a function;
c. providing a system that centrally performs the functions determined in step b); and
d. applying the system to the various applications.

2. A method in accordance with claim 1 wherein the system is a standalone package.

3. A method in accordance with claim 1 wherein the system is an application service provider.

4. A method in accordance with claim 1 wherein the application service provider is in-house.

5. A system of centrally provided common industry applications for organizations within a common industry, the system comprising centrally performed functions for various applications within the common industry regardless of the application that requires a function.

6. A system in accordance with claim 5 wherein the system is a stand-alone package.

7. A system in accordance with claim 5 wherein the system is an application service provider.

8. A method in accordance with claim 5 wherein the application service provider is in-house.

9. A method of doing business by centrally providing common industry applications to organizations within a common industry, the method comprising:
a. identifying functions for various applications within the common industry;
b. determining which functions may be centrally performed regardless of the application that requires a function;
c. providing a system that centrally performs the functions determined in step b);
d. selling the system to at least one industry within the common industry;
e. applying the system to the various applications.

10. A method in accordance with claim 9 wherein the system is a stand-alone package.

11. A method in accordance with claim 9 wherein the system is an application service provider.

12. A method in accordance with claim 9 wherein the application service provider is in-house.

13. A method of centrally providing common industry applications to organizations within a common industry, the method comprising:
a. identifying functions for various applications within the common industry;
b. determining which functions may be centrally performed regardless of the application that requires a function;
c. optimizing functionality of the functions determined in step b);
d. providing a system that centrally performs the functions optimized in step c); and
d. applying the system to the various applications.
